(19) United States
(12) Patent Application Publication
(10) Pub. No.: US 2019/0326665 A1
(43) Pub. Date: Oct. 24, 2019

(54) Antenna Assembly For An Aircraft

(71) Applicant: Airbus Operations GmbH, Hamburg (DE)

(72) Inventors: Uwe Meno Juergens, Hamburg (DE); Matthijs Plokker, Hamburg (DE); Alexander Banavas, Hamburg (DE); Saradhi Nakarikanti, Hamburg (DE)

(73) Assignee: Airbus Operations GmbH, Hamburg (DE)

(21) Appl. No.: 16/380,079

(22) Filed: Apr. 10, 2019

(30) Foreign Application Priority Data
Apr. 23, 2018 (DE) 10 2018 109 723.9

(51) Int. Cl. H01Q 1/28; H01Q 1/12; H01Q 1/42; H01Q 1/50

(52) U.S. Cl. CPC H01Q 1/286; H01Q 1/50; H01Q 1/42; H01Q 1/12

(57) ABSTRACT

An aircraft antenna assembly has a structural section of an aircraft, an antenna element, a cover transparent to radio waves, and a structural element. The structural section has an assembly of interconnected elongate longitudinal and transverse reinforcing elements and an outer skin arranged on one side of the assembly and secured on the reinforcing elements. A surface of the outer skin facing away from the elements forms an outer surface of the structural section. An opening closed by the cover, is formed in the outer skin. In the region of the opening, at least one of the reinforcing elements has a gap, in which the structural element is arranged and which divides the respective reinforcing element into two sections on opposite sides of the gap. The antenna element is arranged in the region of the opening on the opposite side of the outer skin from the outer surface.

### FIELD OF THE INVENTION

The present application relates to an antenna assembly for an aircraft or of an aircraft, which has a fuselage structural section comprising an assembly of interconnected elongate longitudinal and transverse reinforcing elements and an outer skin, an antenna element and a cover transparent to radio waves.

### BACKGROUND OF THE INVENTION

Aircraft typically have one or more antennas, by means of which radio communications can be established between the aircraft and external devices or traffic on the ground or in the air, e.g. other aircraft or satellites.

In the prior art, antennas of this kind have in some cases been mounted externally on the aircraft fuselage, with the result that they project outwards from the aircraft fuselage into the air surrounding the fuselage. As a result, on the one hand, the drag of the aircraft is increased, increasing fuel consumption in operation, and, on the other hand, the aerodynamic pressure and suction forces, also referred to as aero loads, which occur at the outer surfaces of the antenna, must be recalculated for each type of aircraft, for each antenna and for each position of the antenna, resulting in a lot of effort for calculation and certification. Moreover, some antenna elements have been fixed on the fuselage by means of a base plate, which has a relatively high weight and projects into the ambient air together with the actual antenna element.

In other embodiments, antenna elements of such antennas have been integrated directly into the outer skin of the aircraft fuselage by providing them as a layer in a multi-layer outer skin. In the case of such antennas, however, maintenance work and subsequent replacement after manufacture are laborious and, furthermore, their transmission and reception properties are compromised in the case of deformation of the fuselage or outer skin which occurs during the operation of the aircraft.

### BRIEF SUMMARY OF THE INVENTION

Aspects of the present invention may provide an antenna assembly for an aircraft which is of simple and low-cost construction, enables low drag of the aircraft, is easy to install and service and has a low weight, and to provide an aircraft which has an antenna assembly of this kind.

According to an embodiment of the present invention, an antenna assembly for an aircraft or of an aircraft is provided which has a structural section of an or the aircraft—or, to be more precise, a structural section of a structure or partial structure of the aircraft—an antenna element, a cover which is transparent to radio waves, and a, preferably rigid or stiff, structural element.

The structural section, which can be a fuselage structural section of the aircraft or a fuselage structure of the fuselage of the aircraft or a structural section of a tailplane structure of a tailplane or a wing structure of a wing of the aircraft for example, has an assembly of interconnected elongate longitudinal and transverse reinforcing elements. The assembly of interconnected elongate longitudinal and transverse reinforcing elements has an elongate longitudinal reinforcing element or preferably a plurality of elongate longitudinal reinforcing elements, in which case said elements are preferably parallel to one another, and an elongate transverse reinforcing element or preferably a plurality of elongate transverse reinforcing elements, in which case said elements are preferably parallel to one another. The longitudinal reinforcing element or longitudinal reinforcing elements extends or extend at an angle to the transverse reinforcing element or transverse reinforcing elements, wherein the longitudinal reinforcing elements preferably extend in the longitudinal direction of the aircraft fuselage in the state of the structural section in which it is installed in an aircraft, and the transverse reinforcing elements preferably extend in the circumferential direction of the aircraft fuselage in the state of the structural section in which it is installed in an aircraft. The longitudinal reinforcing elements are also referred to as stringers, and the transverse reinforcing elements are also referred to as frames. The longitudinal and transverse reinforcing elements are preferably interconnected in the form of a grid, and therefore form a grid arrangement overall.

The structural section furthermore has an outer skin, which is arranged on one side of the assembly of longitudinal and transverse reinforcing elements—or on one side of the corresponding grid arrangement—and is fixed on the longitudinal and transverse reinforcing elements. This fixing can be performed directly without further elements between the outer skin and the respective longitudinal or transverse reinforcing element or indirectly via intermediate elements and can be different for different longitudinal and transverse reinforcing elements. For example, it is possible to make provision for the outer skin to rest directly on the longitudinal reinforcing elements and to be fixed directly thereon but for clips to be arranged between the transverse reinforcing elements and the outer skin, by means of which clips the outer skin is fixed on the transverse reinforcing elements. In either case, an extended outer skin surface facing away from the longitudinal and transverse reinforcing elements or from the assembly of longitudinal and transverse reinforcing elements forms an outer surface or outer side of the structural section and, in the state of the structural section in which it is installed in an aircraft, of the entire aircraft. In other words, the outer skin is arranged and fixed on the longitudinal and transverse reinforcing elements in such a way that a first outer skin surface faces the assembly of longitudinal and transverse reinforcing elements and a second outer skin surface opposite the first surface forms an outer surface or outer side of the structural section, which faces the environment of an aircraft in the state of the structural section in which it is installed in the aircraft.

The antenna element can be a single one-piece antenna element or an assembly of a plurality of separate antenna elements which interact in order to emit and/or receive radio waves.

The cover is transparent to radio waves emitted by the antenna element in operation and to radio waves receivable or to be received by the antenna element.

An opening or through opening, which can have a circular, oval, round, polygonal, rectangular or square shape for example, is formed in the outer skin. The opening is closed by the cover, i.e. the cover is arranged in such a way that it partially or completely fills or completely covers the opening. In the latter case, it should be noted that it is preferable for the cover to be arranged on the opposite side of the outer skin from the assembly of longitudinal and transverse reinforcing elements, i.e. on the outer surface of the outer skin. However, it is also possible to arrange the cover on the opposite side of the outer skin. Irrespective of the above, it should furthermore be noted that, in the case of an assembly in which the cover fills the opening only partially, the opening can be closed by the cover in combination with one or more further elements, e.g. by one or more sections of the structural element. In the region of the opening, at least one of the longitudinal reinforcing elements and/or at least one of the transverse reinforcing elements in each case has a gap, in which the structural element is arranged and which divides the respective longitudinal or transverse reinforcing element into two sections on opposite sides of the gap. In other words, each such gap extends completely or partially below the opening if the outer surface of the structural section is defined as facing upwards or if the opening is viewed perpendicularly in such a way that the outer skin is between the observer and the assembly of longitudinal and transverse reinforcing elements. All such gaps together form a continuous gap or aperture in the assembly of longitudinal and transverse reinforcing elements, that is to say particularly in the corresponding grid arrangement. Here, a continuous gap or aperture in a grid arrangement is defined as a region through which none of the longitudinal and transverse reinforcing elements passes and which is larger than the normal interspaces between adjacent longitudinal and transverse reinforcing elements, i.e. than the “cells” of the corresponding grid arrangement.

The two sections of each of the longitudinal and transverse reinforcing elements which has one of the gaps are connected to or fixed on the structural element in such a way, preferably rigidly, that tensile and compressive forces acting in the longitudinal direction of the respective longitudinal or transverse reinforcing element, shear forces acting in the transverse direction of the respective longitudinal or transverse reinforcing element and bending forces acting in the respective longitudinal or transverse reinforcing element—particularly around the strong axis thereof for example—are transmitted between the two sections by the structural element. In other words, the two ends of the respective longitudinal or transverse reinforcing element lie opposite one another on opposite sides of the gap, i.e. they delimit or define the gap, wherein the two ends of each of the longitudinal and transverse reinforcing elements which has one of the gaps are connected, preferably rigidly, to the structural element in such a way that the force transmission described can take place. In this context, it should be noted that, depending on the alignment and embodiment of the longitudinal and transverse reinforcing elements, not all of the forces and moments mentioned occur in operation in the state in which they are installed in an aircraft, or at least do not occur in all of the longitudinal and transverse reinforcing elements. If the longitudinal reinforcing elements are designed as stringers and the transverse reinforcing elements are designed as frames, only tensile and compressive forces, but not shear forces and bending moments, occur in the longitudinal reinforcing elements, along the longitudinal axes thereof, for example during the operation of the corresponding aircraft, whereas all the forces and moments mentioned occur in the transverse reinforcing elements and are transmitted by said elements. Accordingly, the longitudinal and transverse reinforcing elements having a gap are connected to the structural element in such a way that said forces and moments are transmitted between the sections if they occur. The connection between the two sections of the corresponding longitudinal and transverse reinforcing elements and the structural element can be established, for example, by riveting and can take place directly or via an intermediate element, such as a connecting hoop, for example.

Alternatively or preferably in addition to this connection between the two sections of each of the longitudinal and transverse reinforcing elements which has one of the gaps and the structural element, the outer skin is furthermore also connected to or fixed on the structural element, more specifically in such a way, preferably rigidly, that shear forces acting on the outer skin are transmitted between opposite sides of the opening by the structural element. It is preferred here if the outer skin is connected to the structural element in the manner described along the entire circumference of the opening. By way of example, the structural element can have an annular section, which surrounds an annular opening, and the outer skin can be connected to or fixed on the annular section over the entire circumference thereof. The connection between the outer skin and the structural element can once again be established, for example, by riveting and can take place directly or via an intermediate element, such as a connecting hoop, for example.

Accordingly, the structural element is a load-bearing element which is integrated directly into the assembly of longitudinal and transverse reinforcing elements or into the outer skin or preferably into the assembly of longitudinal and transverse reinforcing elements and the outer skin, and there is no separate frame around the structural element and the opening which decouples the structural element mechanically from the assembly of longitudinal and transverse reinforcing elements in respect of one or more of the above three instances of force transmission given above. The structural element at least partially or preferably completely replaces those load-bearing parts of the assembly of longitudinal and transverse reinforcing elements and of the outer skin which are absent owing to the gaps or the opening.

It should be noted that the structural element can be connected to a plurality of longitudinal and/or transverse reinforcing elements, thus enabling some of the forces acting on the section of one of the corresponding longitudinal or transverse reinforcing elements to be transmitted or distributed to one or more other ones of the longitudinal or transverse reinforcing elements.

It should furthermore be noted that it is preferred for the structural element to absorb the internal pressure prevailing within the aircraft and, in particular, to close off the opening in a pressure-tight manner in the state in which it is installed in an aircraft. This can be accomplished by embodying the above-described connection between the structural element and the outer skin in a suitable manner and, in particular, by providing it along the entire circumference of the opening, and by the structural element closing off the opening in a pressure-tight manner when viewed from the interior of the aircraft. As an alternative it is possible to provide the cover as a separate pressure-tight closure of the opening, in which case higher requirements are made on the load-bearing capacity of the cover, or to provide a separate pressure-tight closure of the opening different from the cover.

The antenna element is arranged on the opposite side of the outer skin from the outer surface or outer side, in the region of the opening—that is to say completely or at least partially below the opening if the outer surface of the structural section is defined as facing upwards or if the opening is viewed perpendicularly in the manner described above. In other words, the antenna element is within the aircraft in relation to the outer skin in the state of the structural section in which the latter is installed in an aircraft.

The antenna assembly described has the advantage that there is no need for a heavy base plate since there are no aero loads acting on the antenna element, and therefore the antenna assembly can be implemented with a low weight. Moreover, it is simple to install and to service. Since the antenna element does not project outwards from the structural section or aircraft, e.g. the aircraft fuselage in the case of a fuselage structural section, the drag is furthermore not affected in disadvantageous way, and the aircraft can have a better appearance. In contrast to embedding an antenna element as a layer into the outer skin of an aircraft, it is furthermore possible in a simple way to decouple the antenna element mechanically from the structure and thus avoid or at least reduce impairment of the antenna properties by interaction between the antenna element and loads or deformations in the structure. Overall, it is possible to retain the advantages of externally mounted antennas, such as easy installation and servicing, while nevertheless avoiding the disadvantages thereof, in particular high drag.

In a preferred embodiment, the cover is formed by the structural element. In other words, the structural element is the cover. The antenna element can then be arranged and mounted in any desired manner in the interior of the aircraft, provided that the radio waves emitted by it in operation pass out of the aircraft through the cover and that the desired direction of emission and the desired angular range of emission are achieved. In this embodiment, the structural element is preferably plate-shaped and can have the form of a flat or preferably of an arched or curved plate, for example. The structural element can be connected to the two sections of the respective longitudinal or transverse reinforcing elements in such a way that the outer skin is arranged between the structural element and the sections or that it rests directly on the sections. In this embodiment, it is possible for the structural element to be connected in the abovementioned way only to the outer skin, i.e. not to the longitudinal and transverse reinforcing elements, or for the structural element to be connected in the manner likewise mentioned above both to the outer skin and to the longitudinal and transverse reinforcing elements. The latter possibility can be implemented, for example, by the cover resting on an edge region of the outer skin around the opening and being connected in this region to the outer skin, e.g. by means of riveting, wherein the riveting is designed in such a way that it also establishes the connection to the longitudinal and transverse reinforcing elements, either directly or via intermediate elements.

In embodiments in which the cover is formed by the structural element, it is furthermore preferred if the two sections of each or at least some of the longitudinal and transverse reinforcing elements which has/have one of the gaps each have, on their end sections situated opposite one another on both sides of the gap, on the side which faces in the same direction as the outer surface, a depression which extends as far as the gap and in which a section of the structural element is arranged, or a thickened portion which extends as far as the gap and to which a section of the structural element is connected directly or indirectly via an intermediate element. By virtue of the depressions or thickened portions, the two sections have a region of modified thickness at their ends situated opposite one another on both sides of the gap, said region being separated from the region of normal thickness of the respective section by a step, for example. If depressions are provided, the structural element can be arranged in such a way, especially if it is plate-shaped, that it is flush or substantially flush with the outer side of the outer skin, even if the structural element has a greater thickness than the outer skin. A thickened portion, on the other hand, can be provided in order to achieve local reinforcement in the region of the edge of the opening.

In an alternative, preferred embodiment, the structural element and the cover are different components. In this embodiment, it is preferred if at least one section of the structural element surrounds a receiving space in a ring shape and the antenna element is arranged at least partially in the receiving space. For this purpose, the structural element can advantageously be trough-shaped or ring-shaped, for example, wherein the section surrounding the receiving space in a ring shape can have a circular, round, oval, polygonal, rectangular or square shape, for example. In the case of a trough-shaped structural element, the receiving space can be formed by the interior of the trough and, in the case of a ring-shaped structural element, it can be formed by the interior of the ring. However, it is also possible to provide a ring-shaped structural element and to arrange the antenna element outside the receiving space. As has already been mentioned above, the cover or a separate component must absorb the internal pressure in the aircraft in the case of a structural element which is ring-shaped overall. In contrast, a trough-shaped structural element can absorb the internal pressure itself and close the opening in the outer skin.

In a preferred embodiment, the antenna element is mounted or fixed on the structural element and supported by said structural element. It is thereby possible to supply the antenna assembly in a particularly simple way as a unit and to simplify assembly. However, it is also possible for the antenna element to be mounted in the interior of the aircraft independently of the structural element.

In a preferred embodiment, the antenna element is mechanically decoupled from the structural element. This can be accomplished by providing suitable decoupling mechanisms between the antenna element and the structural element or by not mounting or fixing the antenna element on the structural element or supporting it by said structural element.

In a preferred embodiment, the cover comprises a glass-, quartz-, ceramic- or aramid-fibre-reinforced composite material, e.g. in monolithic or sandwich form—especially but not exclusively in embodiments in which the structural element is formed by the cover. Such materials make it possible to provide a high load-bearing capacity.

In a preferred embodiment, the two sections of each of the longitudinal and transverse reinforcing elements which has one of the gaps are reinforced at their end sections situated opposite one another on both sides of the gap—that is to say, in particular, locally in comparison with the rest of the respective section. This can take place, for example, in the form of the already mentioned thickening or, alternatively, in some other way, e.g. by means of modified mechanical properties. In this way, force transmission between the sections to the end sections of which the structural element is connected and the structural element can be improved.

In a preferred embodiment, the antenna assembly furthermore has one or more terminals connected electrically to the antenna element for electrical connection to an external unit and/or has one or more cable leadthrough openings. In particular, the unit can have transmission and/or reception electronics, which transmit and receive radio signals with the aid of the antenna element. If a terminal is provided, this can advantageously be provided or mounted on the structural element, for example, especially in embodiments in which the structural element and the cover are separate components. Irrespective of this, the terminal can advantageously be a standard antenna terminal or the cable leadthrough opening can advantageously be a standard cable leadthrough opening, thus providing a standard interface for connection to the on-board electronics of an aircraft, irrespective of the precise type of antenna element.

In a preferred embodiment, the cover is plate-shaped and is then in the form of a flat or preferably of an arched or curved plate, for example. As an alternative or in addition, it is preferred if an outer surface of the cover is flush or substantially flush with the outer surface of the outer skin. In this way, it is possible to minimize drag.

In a preferred embodiment, the antenna element is a KU-, KA- or L-band antenna. By means of the embodiment of the antenna assembly according to the invention, it is generally and advantageously an easy matter to provide antenna elements of different sizes and, in particular, also relatively large antenna elements on or in an aircraft, e.g. on or in an aircraft fuselage.

The antenna assembly according to one of the embodiments described above is part of an aircraft in the installed state. According to an embodiment of the present invention, an aircraft having a structure and an antenna assembly according to any of the embodiments described herein is therefore also provided. The structure has a multiplicity of longitudinal and transverse reinforcing elements and an outer skin. The structural section is part of the structure, that is to say, in particular, the longitudinal and transverse reinforcing elements of the structural section of the antenna assembly are part of longitudinal and transverse reinforcing elements of the structure. If the structural section is a fuselage structural section, for example, the aircraft has a fuselage and an antenna assembly according to one of the embodiments described herein. The fuselage then has a fuselage structure with a multiplicity of longitudinal and transverse reinforcing elements and an outer skin. The fuselage structural section is part of the fuselage structure, that is to say, in particular, the longitudinal and transverse reinforcing elements of the fuselage structural section of the antenna assembly are part of longitudinal and transverse reinforcing elements of the fuselage.

The aircraft can have one or more of the antenna assemblies. It is advantageous in this case that the antenna assembly can be provided at any desired point in the aircraft and can be provided at any desired point in the fuselage of the aircraft, e.g. on the upper side, on the underside or laterally. The same applies to an assembly on or in other parts of the aircraft, e.g. a tailplane or a wing.

### BRIEF DESCRIPTION OF THE DRAWINGS

Aspects of the invention are explained in greater detail below with reference to the figures, in which two illustrative embodiments are illustrated.

FIG. 1 shows a schematic perspective view of an aircraft having an antenna assembly according to the invention,

FIG. 2a shows a schematic perspective view of an upper side of an antenna assembly according to a first illustrative embodiment of the present invention,

FIG. 2b shows a schematic perspective view of a lower side of the antenna assembly in FIG. 2a,

FIG. 2c shows a schematic cross-sectional view of an aircraft fuselage with the antenna assembly in FIGS. 2a and 2b,

FIG. 3a shows a schematic perspective view of an antenna assembly according to a second illustrative embodiment of the present invention, wherein the outer skin has been omitted for illustration purposes,

FIG. 3b shows a schematic cross-sectional view of the antenna assembly in FIG. 3a,

FIG. 4a shows a schematic perspective view of a lower side of an antenna assembly according to a third illustrative embodiment of the present invention, and

FIG. 4b shows an enlarged view of part of FIG. 4a.

### DETAILED DESCRIPTION

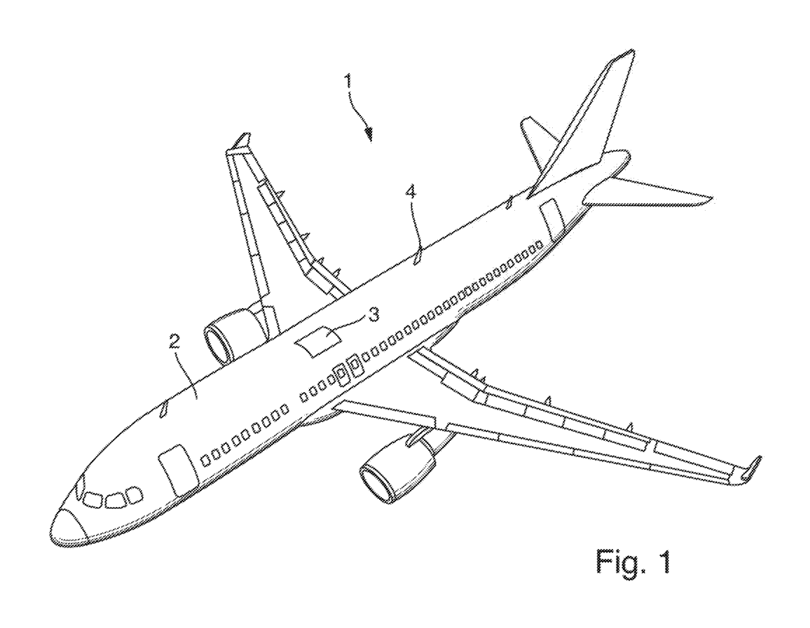

The aircraft 1 shown in FIG. 1 has a fuselage 2 and an antenna assembly 3 according to an embodiment of the invention. In addition to the antenna assembly 3, conventional blade antennas 4, which are secured externally on the fuselage 2 and project outwards from the fuselage 2, are also shown for purposes of illustration. In contrast, the upper side of the antenna assembly 3 is flush or substantially flush with the surface of the fuselage 2, thus ensuring that the drag of the fuselage 2 is not increased or not substantially increased by the antenna assembly 3 and that the antenna assembly is not acted upon by increased or substantially increased aero loads. In FIG. 1, the antenna assembly 3 is arranged on the upper side of the fuselage 2, by way of example. However, it is also possible for the antenna assembly to be situated at any other point on the fuselage 2, e.g. on one side or on the underside. In a conventional way, the fuselage 2 has a fuselage structure having a grid-shaped arrangement of interconnected longitudinal and transverse reinforcing elements, on which an outer skin is arranged (not shown separately for the aircraft in FIG. 1). As can be seen from the other figures, the antenna assembly 3 has a fuselage structural section or fuselage structural element 5, which is part of the fuselage structure of the fuselage 2 and can be formed integrally with the fuselage structure of the fuselage 2 or can be integrated into the latter as a separate component. It should be noted that the antenna assembly 3 can also be provided at points other than the fuselage 2, e.g. on the tailplane or a wing. The figures show arrangement on the fuselage 2 purely by way of example. In the case of arrangement at some other point, a structural section of the corresponding substructure of the aircraft, e.g. a tailplane structural section or a wing structural section, is provided instead of the fuselage structural section 5.

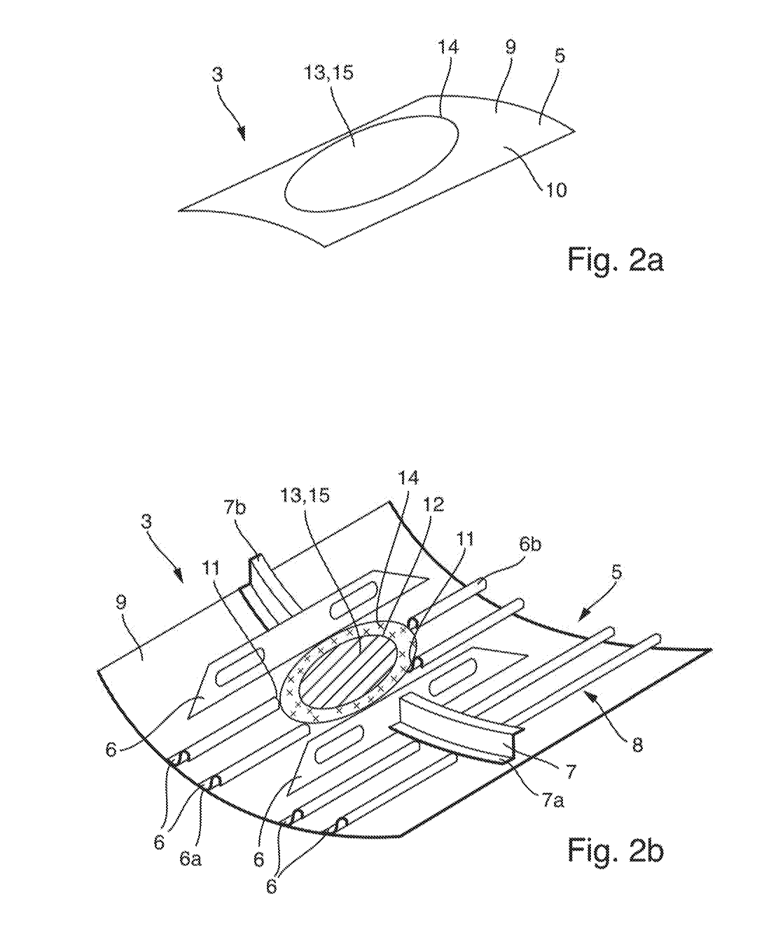

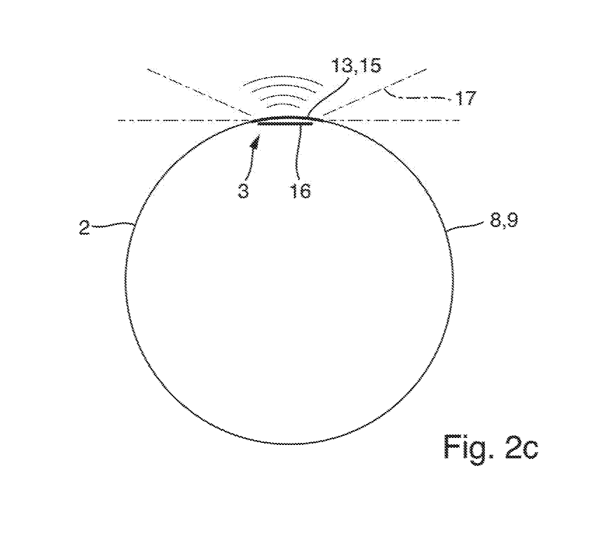

FIGS. 2a to 2c show a first illustrative embodiment of the antenna assembly 3. The antenna assembly 3 has a fuselage structural element 5, the construction of which can be seen more precisely in FIG. 2b. On the one hand, the fuselage structural element 5 has a multiplicity of longitudinal reinforcing elements 6 and a transverse reinforcing element 7, which are interconnected and together form an assembly 8 of longitudinal and transverse reinforcing elements 6, 7. In the state in which they are installed in the fuselage 2, the longitudinal reinforcing elements 6 extend in the longitudinal direction of the fuselage 2, and the transverse reinforcing element 7 extends perpendicularly to the longitudinal reinforcing elements 6 in the circumferential direction of the fuselage 2. On the other hand, the fuselage structural element 5 has an outer skin 9, which is arranged and fixed on one side of the assembly 8. In the state in which it is installed in the fuselage 2, an outer surface 10 of the outer skin 9 forms part of the outer surface or outer side of the fuselage 2. The assembly 8 is situated on the opposite side of the outer skin 9 from the outer surface 10.

Both in the transverse reinforcing element 7 and in two of the longitudinal reinforcing elements 6 there is a gap 11, dividing the respective longitudinal and transverse reinforcing element 6, 7 into two respective sections 6a, 6b and 7a, 7b on both sides of the gap 11. All three gaps 11 together define a continuous gap in the assembly 8, and an opening 12 in the outer skin 9 is formed in this continuous gap (see FIG. 2b). This opening 12 is closed in a pressure-tight manner by a cover 13, which is in the form of a curved plate and is arranged on the outer skin 9 on the side of the outer surface 10 and completely covers the opening 12. In this arrangement, a peripheral edge region 14 of the cover 13 extends beyond the opening 12 over the entire circumference of the latter, and it therefore overlaps with part of the outer skin 9 adjoining the opening 12. In this edge region 14, the cover 13 is fixed on the outer skin 9 and, by means of the latter or via the latter, on the opposite sections 6a, 6b and 7a, 7b, respectively, of the interrupted longitudinal and transverse reinforcing elements 6, 7. However, it is also possible for the cover 13 to be fixed only on the outer skin 9.

In this illustrative embodiment, the cover 13 of the antenna assembly 3 simultaneously forms a load-bearing or load-transmitting structural element 15, by means of which longitudinal forces acting along the longitudinal and transverse reinforcing elements 6, 7, transverse or shear forces acting transversely to the longitudinal and transverse reinforcing elements 6, 7 and torsional forces acting around the longitudinal direction of the longitudinal and transverse reinforcing elements 6, 7 are transmitted between the sections 6a, 6b and 7a, 7b of the interrupted longitudinal and transverse reinforcing elements 6, 7. In this way, weakening of the fuselage structure in the region of the antenna assembly 3 can be avoided or at least kept small.

Finally, the antenna assembly 3 has an antenna element 16 (see FIG. 2c), which is arranged on the opposite side of the outer skin 9 from the outer surface 10 of the outer skin 9 and is therefore situated within the fuselage 2 of the aircraft 1 in the state in which it is installed or integrated in the fuselage 2. In this case, the arrangement of the antenna element 16 within the fuselage 2 is essentially arbitrary as long as the radio waves emitted and to be received by the antenna element 16 can pass with the desired angular emission range 17 through the opening 12 and the cover 13, 15. The cover 13, 15, which is itself designed as a load-bearing structural element 15, is transparent to the radio waves and can consist of or contain a glass- or quartz-fibre-reinforced composite material, for example. The antenna element 16 can be mounted in the interior of the aircraft independently of the fuselage structural section 5 and the fuselage structure of the fuselage 2, thus enabling it to be mechanically decoupled from loads and deformations of the fuselage structure and of the fuselage structural section 5.

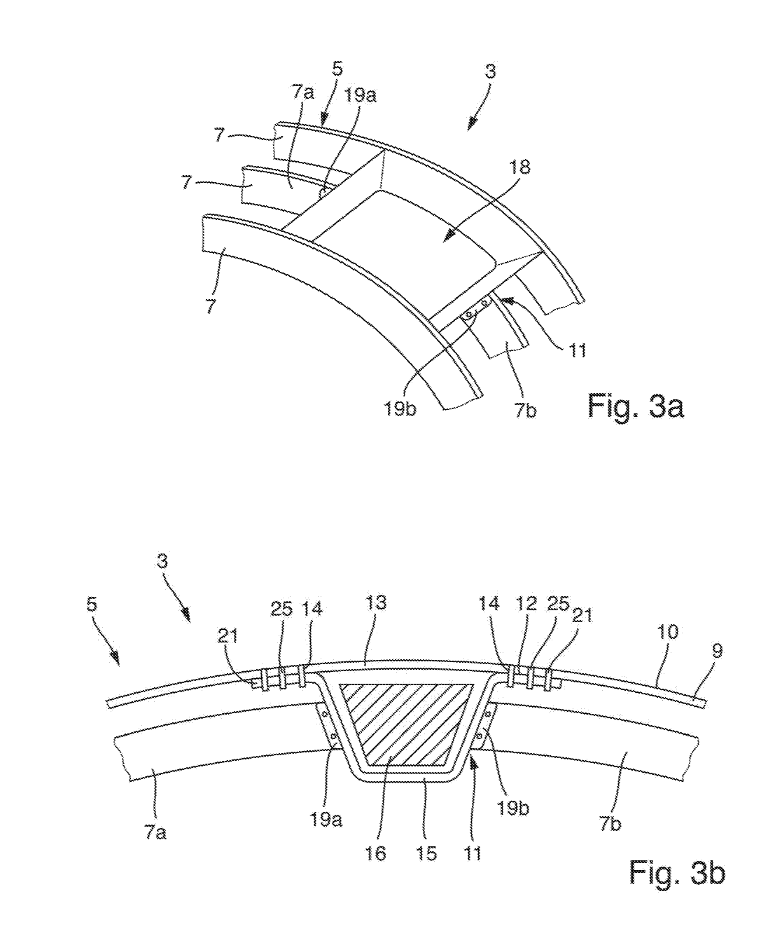

FIGS. 3a and 3b show a second illustrative embodiment of the antenna assembly 3, in which, in contrast to FIGS. 2a to 2c, the cover 13 and the structural element 15 are separate elements or components. Here, the structural element 15 is of trough-shaped design, with the result that it defines a receiving space 18. The antenna assembly 3 in FIGS. 3a and 3b also has a fuselage structural element 5, the construction of which corresponds to that in FIGS. 2a to 2c, and therefore attention is drawn to the above explanations. In FIGS. 3a and 3b, the number of transverse reinforcing elements 7 is just three, of which one has a gap 11. The opening 12 in the outer skin 9 is formed in this gap 11 (see FIG. 3b), and the opening 12 is once again closed by a cover 13, which is in the form of a curved skin and is fixed all the way round in its edge region 14 on the structural element 15.

In contrast to the illustrative embodiment in FIGS. 2a to 2c, however, the cover 13 is not of load-bearing design or does not have to be of load-bearing design. On the contrary, for the purpose of transmitting longitudinal forces acting along the interrupted transverse reinforcing element 7, transverse or shear forces acting transversely to this transverse reinforcing element 7 and bending moments acting in the transverse reinforcing element 7 between the sections 7a, 7b of this transverse reinforcing element 7 and to transmit shear forces acting in the outer skin 9 between opposite sides of the opening 12, the structural element 15 is provided and adapted, said structural element being connected directly in a rigid manner to ends 19a, 19b of the two sections 7a, 7b of the interrupted transverse reinforcing element 7 and being connected to the outer skin 9 around the entire circumference of the trough opening. Thus, force and torque transmission between the sections 7a, 7b and force transmission between sections of the outer skin 9 on opposite sides of the opening 12 takes place via the structural element 15, independently of the cover 13.

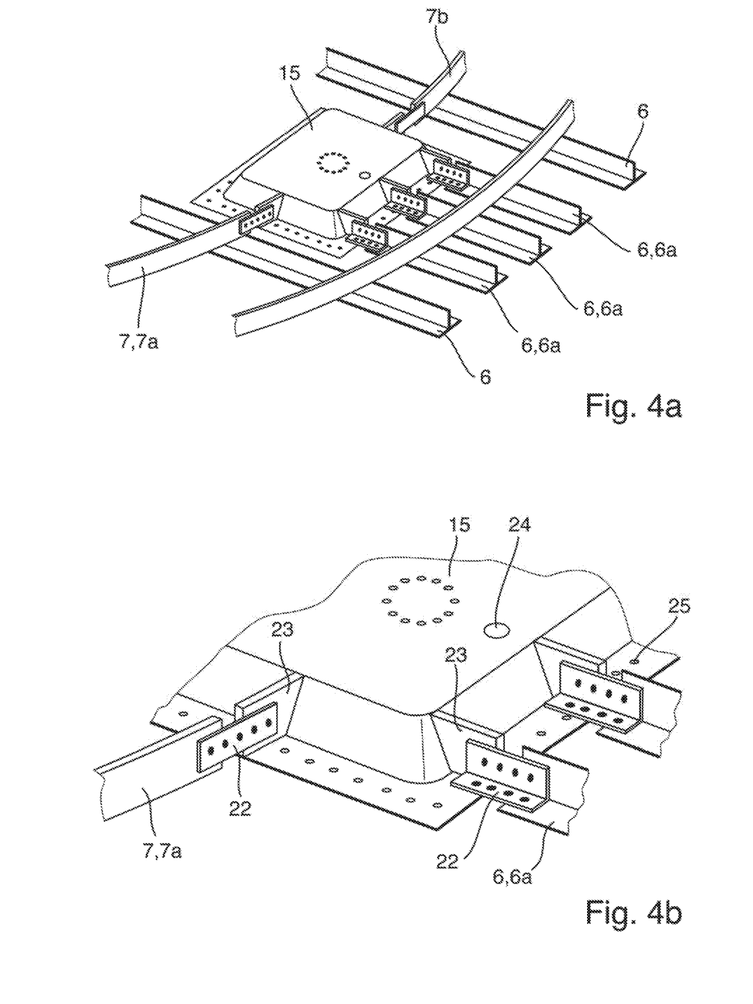

At its upper edge, the structural element 15 has a bent-over peripheral flange section 21, by means of which it rests from below against a peripheral edge region of the outer skin 9 directly adjoining the opening 12 and on which the outer skin is fixed, e.g. by riveted joints 25 of the kind shown in FIGS. 3b and 4b. As a result, it is possible for the cover 13, which is fixed by means of its edge region 14 on the flange section 21 in this example, to be flush or substantially flush with the outer surface 10 of the outer skin 9.

The antenna element 16 is arranged in the receiving space 18 of the structural element 15 and, in relation to the outer skin 9, is therefore situated within the fuselage 2 of the aircraft 1 in the state in which it is installed in an aircraft 1.

The opening 12 is closed in a pressure-tight manner from the inside by the structural element 15, and therefore the structural element 15 absorbs the internal pressure prevailing in the interior of the aircraft. In contrast, the closure of the opening by the cover 13 in this illustrative embodiment serves merely to ensure an outer surface of the antenna assembly or surface of the aircraft which is as smooth as possible.

FIGS. 4a and 4b show a third illustrative embodiment of the antenna assembly 3 from below in a schematic perspective view, said assembly being very largely identical to the second illustrative embodiment in FIGS. 3a and 3b. The only difference consists in that a plurality of longitudinal reinforcing elements 6 also have a gap 11 and that the sections 6a, 6b and 7a, 7b of the interrupted longitudinal and transverse reinforcing elements 6, 7 are each connected to projections 23 on the structural element 15 via a rigid connecting piece 22.

It can also be seen in FIGS. 4a and 4b that a cable leadthrough opening 24, through which a cable for the connection of transmission and/or reception electronics to the antenna element 16 can be passed, is provided in the bottom of the trough-shaped structural element 15.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An antenna assembly for an aircraft, comprising:
a structural section of a structure of an aircraft, comprising:
an assembly of interconnected elongate longitudinal and transverse reinforcing elements; and
an outer skin arranged on one side of the assembly and secured on the longitudinal and transverse reinforcing elements, wherein a surface of the outer skin facing away from said longitudinal and transverse elements forms an outer surface of the structural section;
an antenna element;
a cover transparent to radio waves; and
a structural element,
wherein an opening closed by the cover, is formed in the outer skin, and has a gap) in at least one of the longitudinal reinforcing elements and/or at least one of the transverse reinforcing elements in the region of the opening, in which the structural element is arranged and which divides the respective longitudinal or transverse reinforcing element into two sections on opposite sides of the gap,
wherein the two sections are connected to the structural element in such a way that tensile and compressive forces acting in the longitudinal direction of the respective longitudinal or transverse reinforcing element, shear forces acting in the transverse direction and torsional forces acting around the longitudinal axis are transmitted between the two sections by the structural element, and/or wherein the outer skin is connected to the structural element in such a way that shear forces acting in the outer skin are transmitted between opposite sides of the opening by the structural element, and
wherein the antenna element is arranged in the region of the opening on the opposite side of the outer skin from the outer surface.

2. The antenna assembly according to claim 1, wherein the cover is formed by the structural element.

3. The antenna assembly according to claim 2, wherein the structural element is plate-shaped.

4. The antenna assembly according to claim 2, wherein the two sections of each of the longitudinal and transverse reinforcing elements which has one of the gaps each have, on their end sections situated opposite one another on both sides of the gap, on the side facing the outer surface, a depression extending as far as the gap and wherein a section of the structural element is arranged, or a thickened portion extending as far as the gap and to which a section of the structural element is connected.

5. The antenna assembly according to claim 1, wherein the structural element and the cover are separate components.

6. The antenna assembly according to claim 5, wherein at least one section of the structural element surrounds a receiving space in a ring shape and wherein the antenna element is arranged at least partially in the receiving space.

7. The antenna assembly according to claim 6, wherein the structural element is trough-shaped or ring-shaped.

8. The antenna assembly according to claim 1, wherein the antenna element is mounted on the structural element.

9. The antenna assembly according to claim 1, wherein the antenna element is mechanically decoupled from the structural element.

10. The antenna assembly according to claim 1, wherein the cover comprises a glass-, quartz-, ceramic- or aramid-fibre-reinforced composite material.

11. The antenna assembly according to claim 1, wherein the two sections of each of the longitudinal and transverse reinforcing elements which has one of the gaps are reinforced at the end sections situated opposite one another on both sides of the gap.

12. The antenna assembly according to claim 1, further comprising at least one terminal connected electrically to the antenna element for electrical connection to an external unit and/or has at least one cable leadthrough opening.

13. The antenna assembly according to claim 1, wherein the cover is plate-shaped and/or wherein an outer surface of the cover is flush with the outer surface of the outer skin.

14. The antenna assembly according to claim 1, wherein the antenna element is a KU-, KA- or L-band antenna.

15. An aircraft comprising a structure and an antenna assembly according to claim 1, wherein the structure has a multiplicity of longitudinal and transverse reinforcing elements and an outer skin and wherein the structural section is part of the structure.
